(19) United States
(12) Patent Application Publication
(10) Pub. No.: US 2011/0113935 A1
(43) Pub. Date: May 19, 2011

(54) Vice grip improvement

(76) Inventor: Kyle Hall, Blue Point, NY (US)

(21) Appl. No.: 12/592,036

(22) Filed: Nov. 18, 2009

(51) Int. Cl. B25B 7/12; B25B 7/16

(52) U.S. Cl. 81/367; 81/384

(57) ABSTRACT

An improved locking wrench is provided. The improved locking wrench includes a stationary upper handle which includes a fixed upper jaw, and a lower jaw pivotally connected to said upper handle so that said lower jaw is in opposition to and pivotally movable towards and away from said upper jaw. A lower operating handle having a distal end pivotally is connected to said lower jaw and movable between closed and opened positions which responsively pivotally moves said lower jaw towards and away from said upper jaw. A toggle lever is pivotally coupled at one end to said lower operating handle and has an opposite end coupled operatively to said upper handle. A screw adjustment means having a head portion and a threaded shank portion is threadably engaged with said upper handle and operatively coacting with the opposite end of said toggle lever for effecting clamping force adjustment between said upper and lower jaws, said screw adjustment means defining a hole at least partially formed within said head portion for receiving an item of hardware therein.

### BACKGROUND OF THE INVENTION

1. Field of the Invention

The present invention generally relates to locking-type wrenches and, more specifically, to locking-type wrenches having an adjustment screw which is modified to receive hardware therein.

2. Description of the Background Art

Locking pliers are well known in the art. These devices typically include two jaws that may be locked about an object. The locking is effected by forcing two handles together wherein the handles cooperate to form an over center mechanism.

For example, U.S. Pat. No. 6,578,452 shows a vice grip locking tool that contains jaws that are capable of opening with a flick of the user's wrist. The tool comprises a first handle member, a second handle member, a lower jaw, and an upper jaw. The first handle member is pivotally attached to the lower jaw. The first end of the lower jaw is made up of four mutually interconnected sides having a guided slot extending through it. The upper jaw has an elongated shank that may slide along the guided slot of the lower jaw. A stop is present on the bottom of the shank preventing the upper jaw from escaping the guided slot. The second handle member is pivotally mounted to the lower jaw and includes a releasable lock which is made up of a spring operated detent which engages teeth on the elongated shank.

U.S. Pat. No. 5,357,829 illustrates pliers having opposed gripping tips thereon wherein each gripping tip is figured as a tooth that extends toward the opposite gripping tip.

U.S. Pat. No. 5,022,290 discloses a locking pliers wrench having a first handle member having a first jaw member lockable at a plurality of positions relative to the handle member and removable from the handle member. Different jaw members having different length shanks may be substituted. A second jaw member is pivotally mounted on and straddles the handle member.

U.S. Pat. No. 3,672,245 shows pliers for positively gripping a selected workpiece between substantially parallel gripping jaw surfaces. One of the jaw surfaces is carried by a fixed handle. The other is carried by a pivoted toggle member mounted on an extension of the fixed handle for pivotal movement and adjustment toward and away from the jaw surface on the fixed handle.

U.S. Pat. No. 3,241,410 consists of a combination quick set and vise grip wrench wherein toggle action levers in the handles pivotally urge an elongate shank and associated moveable jaw toward a stationary jaw with gripping action.

U.S. Pat. No. 2,905,038 describes a toggle wrench with slidable adjustment. The wrench comprises a vice grip or quick set type which employs an over center mechanism.

U.S. Patent Application Number U.S. 2003/0221523 depicts an adjustable pliers wrench including a fixture having a handle and an opposing stationary jaw, a coacting jaw pivoted to the fixture, and a lever pivoted to the coacting jaw. A guide is attached proximate the handle and a locking element is arranged on the guide for reciprocal and canting movement. At least one attached biasing element urges the locking element toward the stationary jaw. An arm is pivoted to the lever and a cam is pivoted to the arm and to the locking element so as to be movable between a first condition permitting the locking element to reciprocate along the guide and a second condition bearing against the guide and canting the locking element into frictional engagement against the guide.

The prior art offers many modifications and improvements to locking type pliers. However, what is not found in the prior art is an effective means for attaching objects to the locking type pliers while the pliers are attached to an object.

### SUMMARY OF THE INVENTION

It is an object of the present invention to provide an effective means for attaching objects to the locking type pliers while the pliers are attached to an object.

The improved locking wrench includes a stationary upper handle which includes a fixed upper jaw, and a lower jaw pivotally connected to said upper handle so that said lower jaw is in opposition to and pivotally movable towards and away from said upper jaw. A lower operating handle having a distal end pivotally is connected to said lower jaw and movable between closed and opened positions which responsively pivotally moves said lower jaw towards and away from said upper jaw. A toggle lever is pivotally coupled at one end to said lower operating handle and has an opposite end coupled operatively to said upper handle. A screw adjustment means having a head portion and a threaded shank portion is threadably engaged with said upper handle and operatively coacting with the opposite end of said toggle lever for effecting clamping force adjustment between said upper and lower jaws, said screw adjustment means defining a hole at least partially formed within said head portion for receiving an item of hardware therein.

The invention is not limited to the above-described embodiments, and various changes are possible without departing from the principles set forth herein. Furthermore, the embodiments include the invention at various stages, and various inventions can be extracted by properly combining multiple disclosed constructional requirements. There are many applications of this design.

The above is a brief description of some deficiencies in the prior art and advantages of the present invention. Other features, advantages and embodiments of the invention will be apparent to those skilled in the art from the following description and drawings.

### BRIEF DESCRIPTION OF THE DRAWINGS

The invention will become more clearly understood from the following detailed description in connection with the accompanying drawings, in which:

FIG. 1 is a perspective view illustrating a conventional locking pliers;

FIG. 2 is a perspective view illustrating a conventional locking pliers;

FIG. 3 is a perspective view illustrating a locking pliers having an improved adjustment screw in accordance with an embodiment of the present invention; and

FIG. 4 is a perspective view illustrating an improved adjusting screw for use with a locking pliers, in accordance with an embodiment of the present invention.

### DETAILED DESCRIPTION OF THE PREFERRED EMBODIMENTS

The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein.

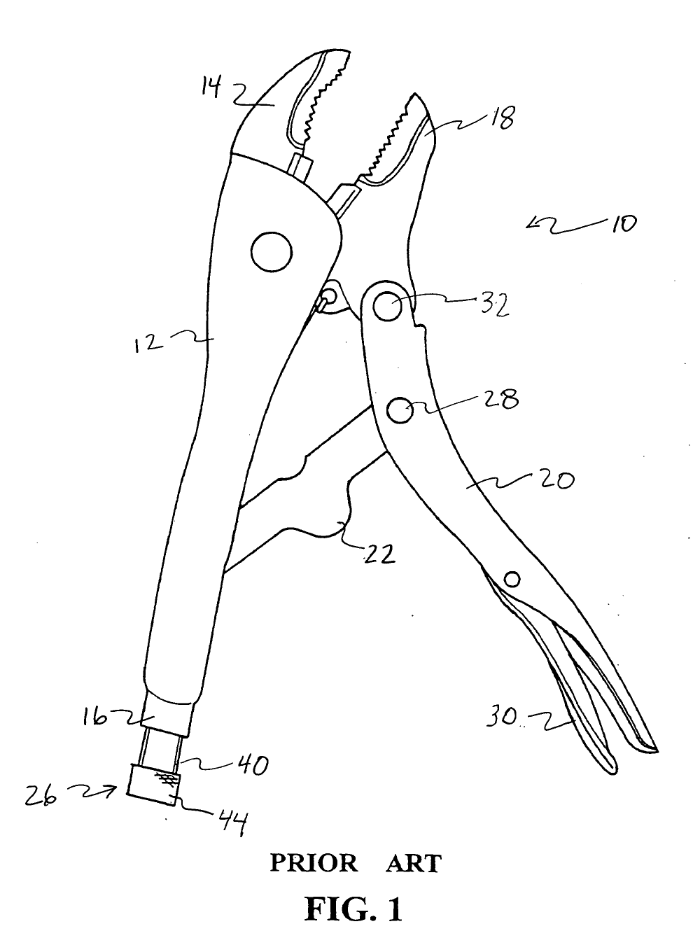

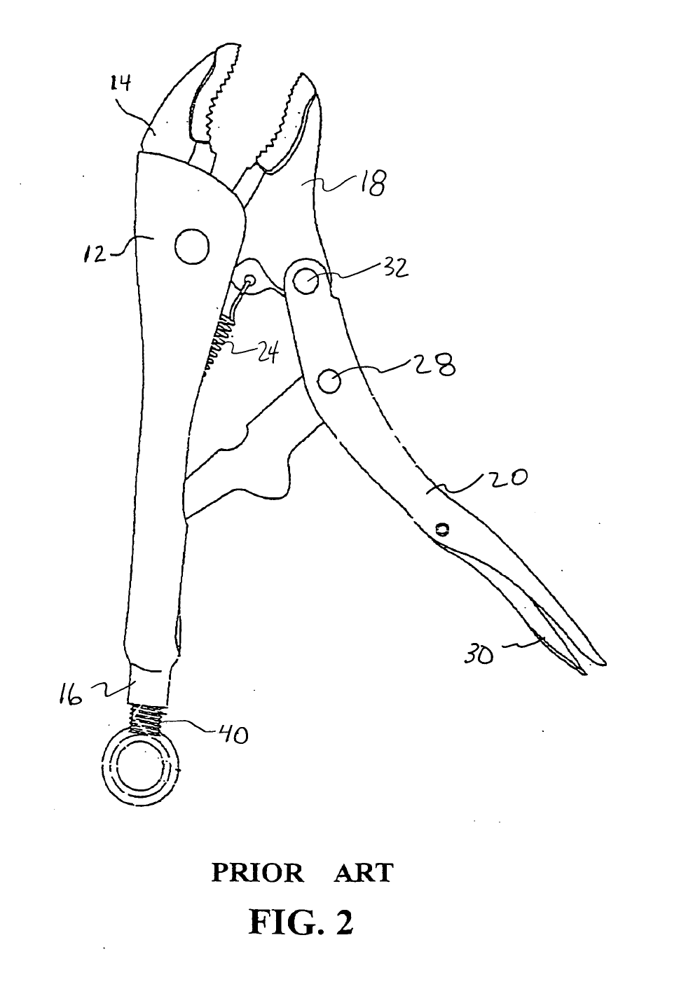

Referring now to the drawings in detail, and initially to FIGS. 1 and 2, there is shown a perspective view illustrating a conventional locking pliers 10. Conventional locking pliers (also referred to as locking wrenches or vice grips) are generally comprised of an upper handle 12 having a fixed-position upper jaw 14 at its forward end and a threaded sleeve 16 at its rearward end. A pivotally movable lower jaw 18 is disposed in opposition to the upper jaw 14 and is moved towards and away from the upper jaw 14 by means of a lower operating handle 20 (which is itself pivotally connected to the lower jaw 18). A toggle lever 22 extends between the upper handle 12 and the lower operating handle 20. The toggle lever 22 is pivotally connected at one of its ends to the lower operating handle 20 at a pivot pin 28 rearwardly of the pivot pin 32 and is axially slidably received within the upper handle 12 by suitable means (not shown) at the other of its ends. Typically, a tension spring 24 (best shown in FIG. 2) biases the lower jaw 18 in a pivotal direction tending to separate it from the upper jaw 14. An adjustment screw 26 is threadably coupled within the sleeve 16 of the upper handle 12 and has a terminal end that acts upon the opposite end of the toggle lever 22. A release lever 30 is provided so as to facilitate release of the clamping force between jaws 14 and 18—that is, to facilitate movement of the lower operating handle 20 from its closed condition to its opened condition.

The threaded shank 40 of adjustment screw 26 is coupled operatively to the threaded sleeve 16 which extends axially within the rearward end of the upper handle 12. As is well known in this art, the terminal end of the threaded shank 40 will coact with the toggle lever 22 so as to in turn allow the operator to select the clamping force exerted between the upper and lower jaws 14, 18, respectively (i.e., in dependance upon the direction of turning movements applied to the adjustment screw 26). Preferably, the adjusting screw includes a knurled knob portion 44 on an end thereof to facilitate easy manual rotation of the screw by the user.

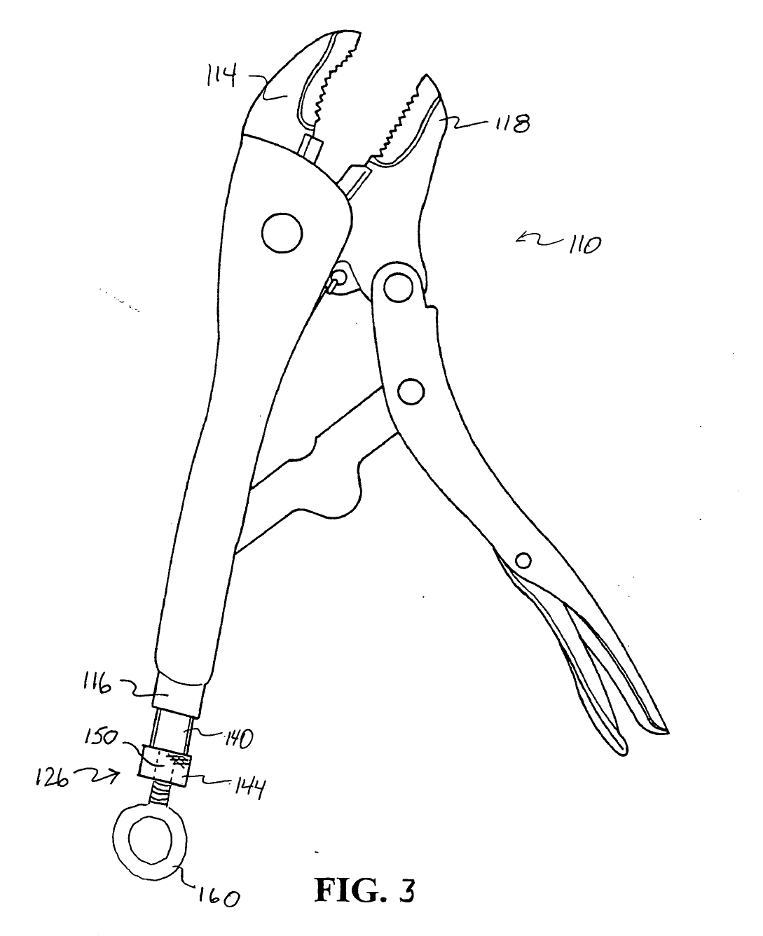

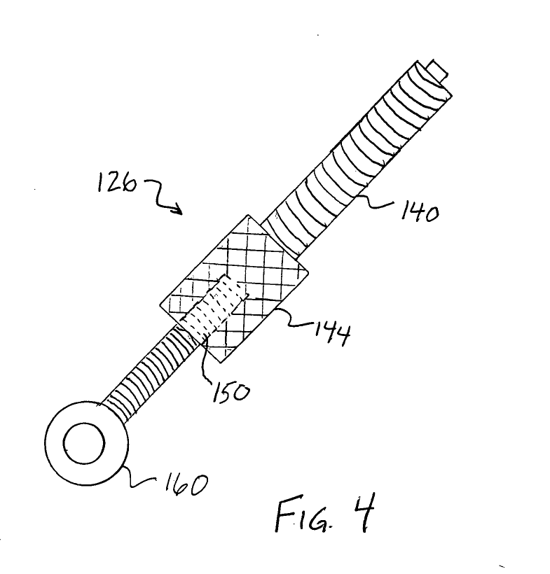

The improvements according to the present invention are essentially embodied in the adjustment screw. In this regard, as illustrated in FIGS. 3 and 4, the adjustment screw 126 is preferably modified to have a hole 150 formed at least partially within the knurled knob portion 144. Preferably the inner surface of the hole 150 is threaded to receive any one of a number of hardware pieces 160 as desired by a user to fit a particular application.

Advantageously, in accordance with the present invention, the upper and lower jaws 114 and 118, respectively, of locking pliers 110 may be clamped on an object and the clamping force may be set by means of adjustment screw 126 and then a piece of hardware 160 may be inserted, removed, and/or replaced without removing the locking pliers from the clamped object and without losing the adjustment made by adjusting screw 126.

The hardware 160 illustrated in FIGS. 3 and 4 threadably engaged within hole 150 is an eye bolt. However, it is contemplated that the eye bolt 160 may be replaced by a hook or any other piece of hardware known to one having ordinary skill in the art. Preferably, the hole 150 is a 5/16 inch threaded opening but it is contemplated that it may be of a variety of sizes and thread configurations. It is also contemplated that the hardware 160 may be connected to adjustment screw 126 by means of welding or any other means known to one having ordinary skill in the art.

The adjustment screw 126 with hole 150 formed therein may also be provided to the market as a “retrofit” item as a replacement for the knurled knob adjustment screw conventionally associated with locking wrenches. Hence, the functional attributes mentioned above can be realized by replacing the conventional knurled knob adjustment screw of those locking wrenches currently in the market with the novel adjustment screw 126 having hole 150 according to the present invention.

While a conventional pair of jaws associated with the locking wrenches of this invention has been shown in the accompanying drawings, they are simply representative of any opposing movable members that may be acted upon using a toggle lever according to the general principles of locking-type wrenches. Thus, the term “jaws” as used herein and in the accompanying claims should be interpreted broadly to include any opposing structural member which is otherwise associated with a locking-type wrench of the variety described previously.

Although the present invention has been described in accordance with the embodiments shown, one of ordinary skill in the art will readily recognize that there could be variations to the embodiment and these variations would be within the spirit and scope of the present invention. Furthermore, it is contemplated that the present invention may be manufactured of various materials and in different sizes. Accordingly, many modifications may be made by one of ordinary skill in the art without departing from the spirit and scope of the invention.

What is claimed is:

1. A locking wrench comprising:
a stationary upper handle which includes a fixed upper jaw, and a lower jaw pivotally connected to said upper handle so that said lower jaw is in opposition to and pivotally movable towards and away from said upper jaw;
a lower operating handle having a distal end pivotally connected to said lower jaw and movable between closed and opened positions which responsively pivotally moves said lower jaw towards and away from said upper jaw;
a toggle lever pivotally coupled at one end to said lower operating handle and having an opposite end coupled operatively to said upper handle; and
screw adjustment means having a head portion and a threaded shank portion threadably engaged with said upper handle and operatively coacting with the opposite end of said toggle lever for effecting clamping force adjustment between said upper and lower jaws, said screw adjustment means defining a hole at least partially formed within said head portion for receiving an item of hardware therein.

2. A locking wrench as in claim 1, wherein the inner surface of the hole in the screw adjustment means is threaded for threadably receiving the item of hardware.

3. A locking wrench as in claim 1, wherein the item of hardware is an eye bolt.

4. A locking wrench as in claim 1, wherein the item of hardware is a hook.

5. A locking wrench as in claim 1, wherein the item of hardware is welded to the head portion of the adjustment screw.

6. A locking wrench as in claim 1, wherein said head portion of said adjustment screw has a generally cylindrical exterior surface.

7. A locking wrench as in claim 1, wherein said head portion of said adjustment screw has a knurled exterior surface.

8. A locking wrench comprising:
an upper handle having a threaded sleeve at a rearward end thereof, and an upper jaw rigidly connected to a forward end thereof;
a lower jaw pivotally connected to said upper handle in opposition to said upper jaw;
a lower operating handle having a forward section pivotally connected to said lower jaw for pivotally moving said lower jaw between clamped and unclamped positions relative to said upper jaw;
a toggle lever pivotally connected at one end to said lower operating handle rearwardly of said forward section that is pivotally connected to said lower jaw, and having another end which is axially slidably received within said upper handle;
an adjustment screw having a head portion and a threaded shank that is threadably coupled to said threaded sleeve of said upper handle for acting upon said another end of said toggle lever to axially slidably move said toggle lever within said upper handle whereby clamping force between said upper and lower jaws is adjusted, said screw adjustment means defining a hole at least partially formed within said head portion for receiving an item of hardware therein.

9. A locking wrench as in claim 8, wherein the inner surface of the hole in the screw adjustment means is threaded for threadably receiving the item of hardware.

10. A locking wrench as in claim 8, wherein the item of hardware is an eye bolt.

11. A locking wrench as in claim 8, wherein the item of hardware is a hook.

12. A locking wrench as in claim 8, wherein the item of hardware is welded to the head portion of the adjustment screw.

13. A locking wrench as in claim 8, wherein said head portion of said adjustment screw has a generally cylindrical exterior surface.

14. A locking wrench as in claim 8, wherein said head portion of said adjustment screw has a knurled exterior surface.
